(19) United States
(12) Patent Application Publication
(10) Pub. No.: US 2006/0278481 A1
(43) Pub. Date: Dec. 14, 2006

(54) Deflashing device

(75) Inventor: Allen B. Chavis, Laurinburg, NC (US)

Correspondence Address: THE WEBB LAW FIRM, P.C., 700 KOPPERS BUILDING, 436 SEVENTH AVENUE, PITTSBURGH, PA, 15219, US

(73) Assignee: RFPC Holding Corporation, Wilmerding, PA (US)

(21) Appl. No.: 11/448,944

(22) Filed: Jun. 7, 2006

Related U.S. Application Data
(60) Provisional application No. 60/688,416, filed on Jun. 8, 2005.

(51) Int. Cl. F16D 65/04; F16D 69/00

(52) U.S. Cl. 188/250 D

(57) ABSTRACT

A deflashing device for removing excess friction material from a dovetail guide of a brake includes a base for supporting an actuator attached to the base, a slide, at least one pair of cutters and a slide guide attached to the base. The slide is in communication with the actuator and positionable by the actuator. The at least one pair of cutters is positioned on the slide opposed to one another and adapted to engage the dovetail guide of the brake. The slide guide is in communication with the slide for slidably mounting the slide to the base wherein the actuator manipulates the slide for removing excess friction material from the dovetail guide of the brake.

### BACKGROUND OF THE INVENTION

1. Field of the Invention

The present invention relates generally to devices and tools, typically used in brake manufacturing processes in connection with deflashing brakes and, more specifically, to a device capable of removing flash from a dovetail guide of a disc.

2. Description of Related Art

Disc brakes are commonly used in railroad applications having various systems for attachment of the disc brakes to a brake head. Dovetail guides are a common way of connecting the disc brake with the brake head, particularly in railroad applications, and thus are generally known in the art. These disc brakes may have a disc pad comprised of friction material that may be molded or otherwise affixed to a backing plate of the disc brake. The dovetail guides are often a feature of the backing plate and are provided to interlock with the brake head. Accordingly, the brake head will have corresponding wedged shaped groves to receive the dovetail guides of the backing plates for employing the disc brakes on the railroad machinery. Various locking devices are known for preventing the installed disc brake from coming out of the corresponding wedge shaped grooves while permitting removal of the same.

In the manufacture of the disc brakes, it is known that molding the friction material to the backing plate is an affordable and effective method for attaching the backing plate to the brake pad. However, during the molding process, excess friction material may adhere to the backing plate. This excess friction material is commonly referred to as flash. The flash on the backing plate, and more particularly that which collects within the dovetail guides, creates many problems including a lack of conformity to specifications required for proper installation on standardized brake heads for railroad applications. When flash builds up in the dovetail guide area, the disc brakes are unable to be slid into the corresponding wedge shaped grooves of the brake head, thus requiring additional work in order to use such disc brakes.

In order to prevent waste due to non-conforming disc brakes having flash on the backing plate, disc brake manufacturers have used many labor-intensive processes to clean and remove any problematic areas of the backing plate having flash. For example, it has been known to grind the flash off of the backing plate, thus deflashing the backing plate. U.S. Pat. No. 5,396,972 to Grele describes such a process for cleaning up and deflashing the backing plate. Often, the deflashing is accomplished via filing the flash in the dovetail guide by hand with special modified files that add significant expense to the cost of manufacturing. Further, hand filing of backing plates adds significant labor expense to effectively file the backing plates and requires the laborer to physically handle and work on the backing plate which could result in injury where the laborer does not follow recommended procedures. Accordingly, many of the prior art processes are inefficient, labor intensive, and may not accurately remove flash, which thus creates waste and confounds the initial purpose of deflashing the backing plate.

### SUMMARY OF THE INVENTION

Accordingly, it is an object of the present invention to provide a deflashing device that addresses one or more of the above-identified concerns and overcomes the shortcomings of conventional processes in the art of deflashing disc brakes. It is another object of the present invention to provide an accurate deflashing device that includes beneficial structure to enhance and optimize the deflashing process required to effectively and accurately deflash the backing plate and, more specifically, the dovetail guide. The present invention will reduce the amount of labor required for deflashing and will decrease waste while providing consistent results. It is a further object of the present invention to provide a deflashing device that provides additional safety to a user when deflashing the backing plate. In accordance with the broad teachings of the present invention, a deflashing device is provided.

In particular, a deflashing device is provided for engaging, contacting, cutting and/or separating flash from, or otherwise deflashing, a backing plate including the dovetail guide. The deflashing device includes a base for supporting an actuator attached to the base, a slide, at least one pair of cutters and a slide guide. The slide is in communication with the actuator and positionable by the actuator. The at least one pair of cutters is positioned on the slide opposed to one another and are adapted to engage the dovetail guide of the brake. The slide guide is attached to the base and is in communication with the slide for slidably mounting the slide to the base. Further, the actuator manipulates the slide for removing excess friction material from the dovetail guide of the brake.

The deflashing device may also include cutters that have a cutting end adapted to engage the dovetail guide of the brake and an attachment end for attaching the cutters on the slide. The cutters may also have an angular profile for engaging and removing excess friction material from the dovetail guide of the brake. Further, the deflashing device may have at least one push bar adapted to communicate with and reposition at least one of the cutters when the push bar is forced into contact with the at least one of the cutters. This embodiment may also provide that the cutters are pivotably attached to the slide at the attachment end of the cutters, wherein the slide has chamfer portions adapted to permit the attachment end of the at least one of the cutters to be repositioned by the at least one push bar.

In other embodiments, the slide of the deflashing device has opposing attachment portions each having at least one of the cutters positioned thereon. Further, the deflashing device may include at least two pairs of cutters positioned on the slide opposed to one another.

A second pair of cutters may also be provided and positioned on a second slide opposed to one another to engage the dovetail guide of the brake. The second slide may be in communication with a second actuator attached to the base, wherein the second slide is positionable by the second actuator. A second slide guide may also be included that is attached to the base and in communication with the second slide guide for slidably mounting the second slide to the base. Further, the second actuator manipulates the second slide for removing excess friction material from the dovetail guide of the brake.

The deflashing device may further include a lid having a handle attached wherein the lid is adapted to enclose the slide and the cutters for protecting a user from the cutters when the lid is closed against a compartment base. An indicator may also be attached to the lid to communicate with the actuator when the lid is in a closed position to activate the actuator.

In one embodiment, the deflashing device may include a piston positioned between the slide and the actuator to position the slide. Further, the slide guide may be affixed to an end plate attached to the base at one end and attached to the slide at an opposing end of the slide guide. The deflashing device may further comprise a locator positioned on the end plate adapted to prevent the slide from being manipulated beyond the locator.

Another embodiment includes a deflashing device for removing excess material from a dovetail guide of a brake comprising a base, a first actuator, a second actuator, a first end plate, a second end plate, a first slide, a second slide, a first slide guide, and a second slide guide. The base has a first end and a second end. The first actuator may be attached to the first end of the base, wherein the first actuator has a first piston extending away from the first actuator toward the second end. The second actuator may be attached to second end of the base, wherein the second actuator has a second piston extending away from the second actuator toward the first end. The first end plate may be attached to the base having the first piston extending therethrough, while the second end plate may be attached to the base having the second piston extending therethrough. The first slide may be attached to the first piston and may have a forward attachment portion and a rearward attachment portion, wherein the attachment portions are positioned opposed to each other and each attachment portion has at least one first cutter positioned thereon. The second slide may be attached to the second piston and may have a second forward attachment portion and a second rearward attachment portion, wherein the second attachment portions are positioned opposed to each other and each second attachment portion has at least one second cutter positioned thereon. The first slide guide extends between the first end plate and the first slide for slidably mounting the first slide to the base, wherein the first actuator is adapted to manipulate the first slide toward the first end for removing excess friction material from the dovetail guide of the brake with the at least one first cutter. In addition, the second slide guide extends between the second end plate and the second slide for slidably mounting the second slide to the base, wherein the second actuator is adapted to manipulate the second slide toward the second end for removing excess friction material from the dovetail guide of the brake with the at least one second cutter.

The deflashing device may further include a lid adapted to enclose the first and second slides and the first and second cutters for protecting a user from the first and second cutters when the first and second the cutters are manipulated. An indicator may also be provided and attached to the lid for communicating with the first and second actuators when the lid is in a closed position to activate the actuators. The first and second actuators may also manipulate the first and second slides toward each other when the lid is moved from a closed position with the indicator communicating with the first and second actuators to an open position wherein the indicator is no longer in communication with the first and second indicators. In addition, the first and second cutters may have an angular profile for engaging and removing excess friction material from the dovetail guide of the brake.

The deflashing device may further include a first locator positioned on the first end plate adapted to prevent the first slide from being manipulated beyond the first locator. In addition, a second locator may be positioned on the second end plate adapted to prevent the second slide from being manipulated beyond the second locator.

These and other features and characteristics of the present invention, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures.

### BRIEF DESCRIPTION OF THE DRAWINGS

FIG. 1 is a perspective view of a known disc brake;

FIG. 2 is a perspective view of another embodiment of a known disc brake;

FIG. 3 is a perspective view of a disc brake before deflashing;

FIG. 4 is a perspective view of the disc brake shown in FIG. 3 after deflashing;

FIG. 5 is a side plan view of one embodiment of a pair of cutters of the deflashing device engaging a backing plate according to the present invention;

FIG. 6 is a cross-sectional view of the cutters in FIG. 5 in a plane intersecting push bar bores, wherein the cutters of the deflashing device are in a disengaged position;

FIG. 7 is a side plan view of an embodiment of a cutter according to the present invention;

FIG. 8 is rear plan view of the cutter in FIG. 7;

FIG. 9 is a side plan view of one embodiment of a slide according to the present invention;

FIG. 10 is a rear plan view of the slide shown in FIG. 9;

FIG. 11 is a side plan view of another embodiment of a slide according to the present invention;

FIG. 12 is a rear plan view of the slide shown in FIG. 11;

FIG. 13 is a top plan view of an embodiment of a deflashing device according to the present invention;

FIG. 14 is a perspective view of an embodiment of a deflashing device according to the present invention;

FIG. 15 is a perspective view of the deflashing device shown in FIG. 14 having a disc brake positioned thereon;

FIG. 16 is a front plan view, illustrating a cutaway of a compartment base, of the deflashing device shown in FIG. 13 having a compartment lid and a disc brake positioned thereon;

FIG. 17 is a side plan view of the deflashing device shown in FIG. 16;

FIG. 18 is a front plan view of a deflashing device in use in deflashing a disc brake according to the present invention;

FIG. 19 is a front plan view of a deflashing device in use in deflashing a disc brake having a lid covering the disc brake according to the present invention;

FIG. 20 is a bottom plan view of a base in the deflashing device shown in FIG. 13;

FIG. 21 is a front plan view of the base shown in FIG. 20;

FIG. 22 is a side plan view of a locator of the deflashing device shown as shown in FIG. 13;

FIG. 23 is a top plan view of the first locator shown in FIG. 22;

FIG. 24 is a front plan view of the first locator shown in FIG. 22;

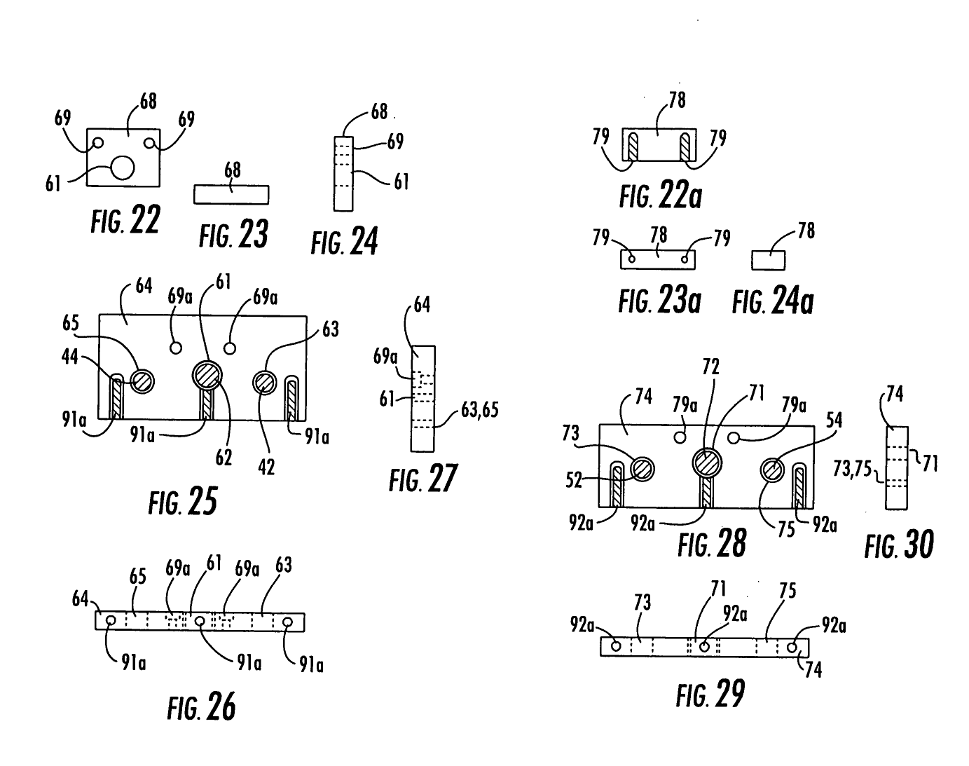

FIG. 22a is a top plan view of a locator of the deflashing device shown as shown in FIG. 14;

FIG. 23a is a side plan view of the first locator shown in FIG. 22a;

FIG. 24a is a front plan view of the first locator shown in FIG. 22a;

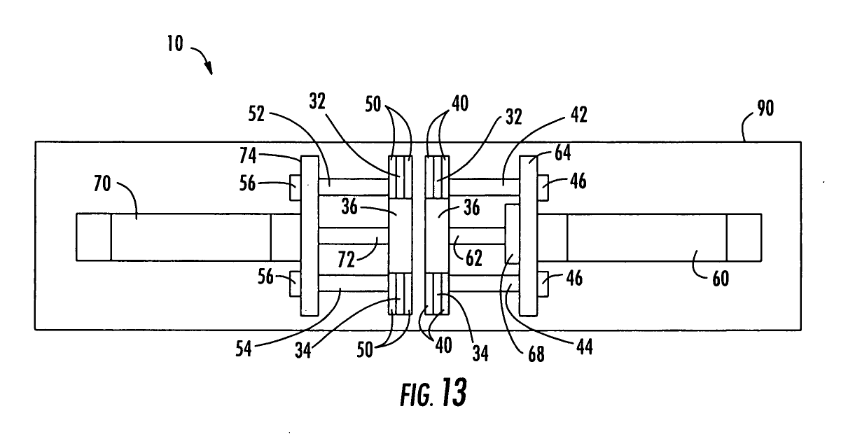

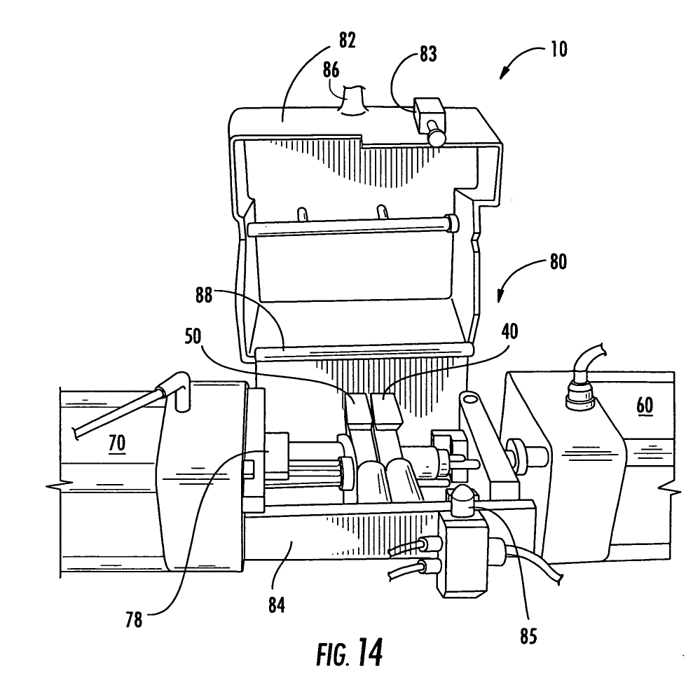

FIG. 25 is a side plan view of a first end plate in the deflashing device shown in FIG. 13;

FIG. 26 is a bottom plan view of the first end plate shown in FIG. 25;

FIG. 27 is a front plan view of the first end plate shown in FIG. 25;

FIG. 28 is a side plan view of a second end plate in the deflashing device shown in FIG. 13;

FIG. 29 is a bottom plan view of the second end plate shown in FIG. 28; and

FIG. 30 is a front plan view of the second end plate shown in FIG. 28.

### DESCRIPTION OF THE PREFERRED EMBODIMENTS

For purposes of the description hereinafter, the terms “upper”, “lower”, “right”, “left”, “vertical”, “horizontal”, “top”, “bottom”, “lateral”, “longitudinal” and derivatives and/or variations thereof shall relate to the invention as it is oriented in the drawing figures. However, it is to be understood that the invention may assume various alternative configurations and step sequences, except where expressly specified to the contrary. It is also to be understood that the specific devices and processes illustrated in the attached drawings, and described in the following specification, are simply exemplary embodiments of the invention. Hence, specific dimensions and other physical characteristics related to the embodiments disclosed herein are not to be considered as limiting.

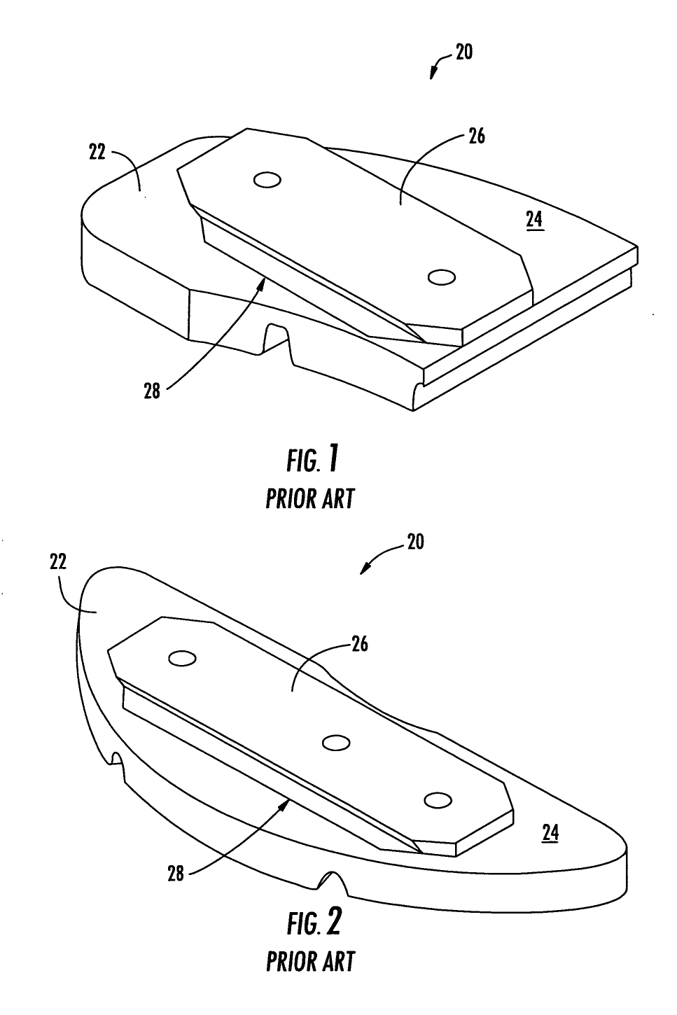

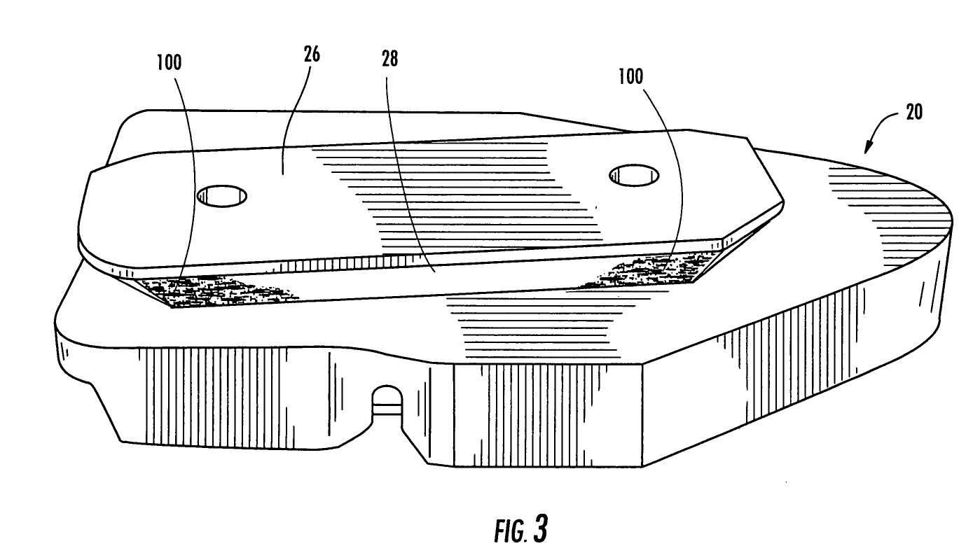

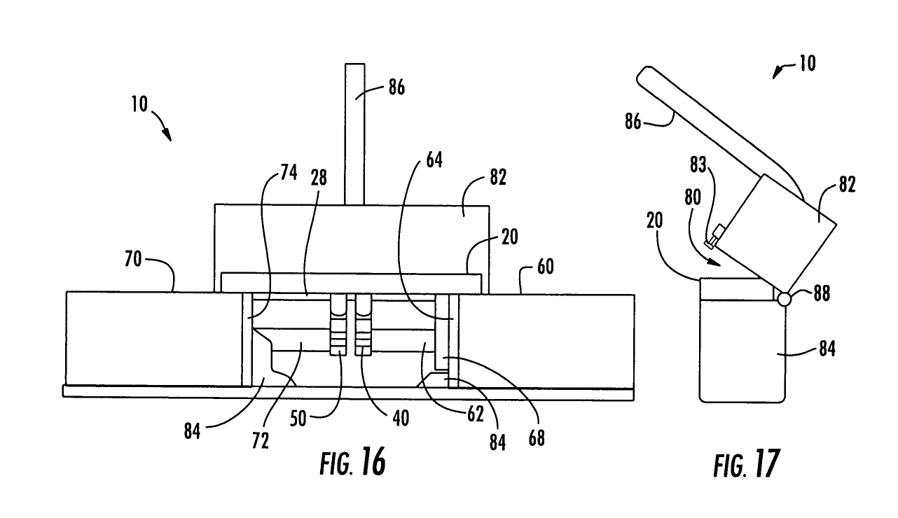

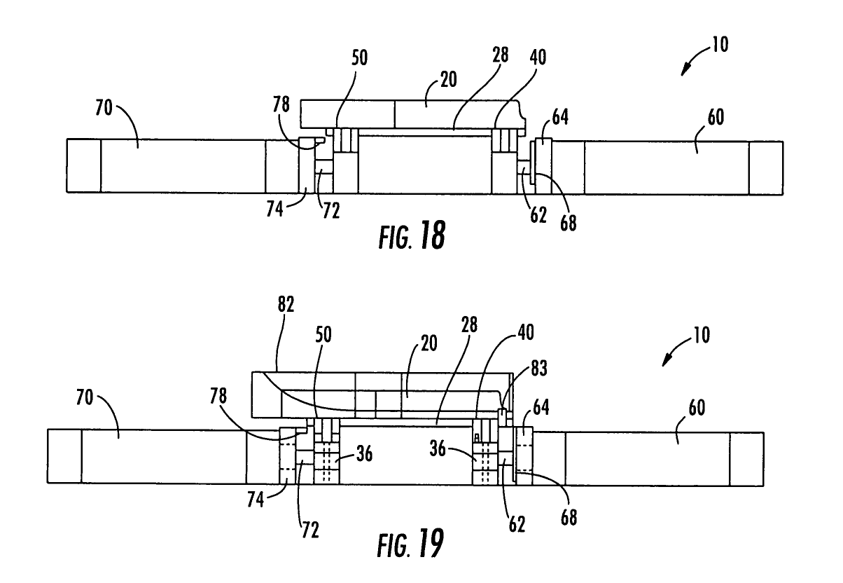

The present invention is directed to a deflashing device 10, as shown in various embodiments in various views, as well as in use, in FIGS. 5, 6 and 15-19. The deflashing device 10 is used to remove flash 100, shown in FIG. 3, through a cutting process to deflash a disc brake 20. FIGS. 1, 2 and 4 illustrate deflashed disc brakes 20.

As shown in FIGS. 1-4, the disc brake 20 has friction material 22 and a backing plate 26. The friction material 22 may have a horizontal surface 24 on one side of the friction material 22 that may be formed, molded and/or connected to the backing plate 26. The backing plate 26 is generally provided for attachment of the disc brake 20 to a brake head (not shown) of a railroad machine. The illustrated embodiment of backing plate 26 has at least one dovetail guide 28 that may assist the disc brake 20 in attachment to the railroad machine.

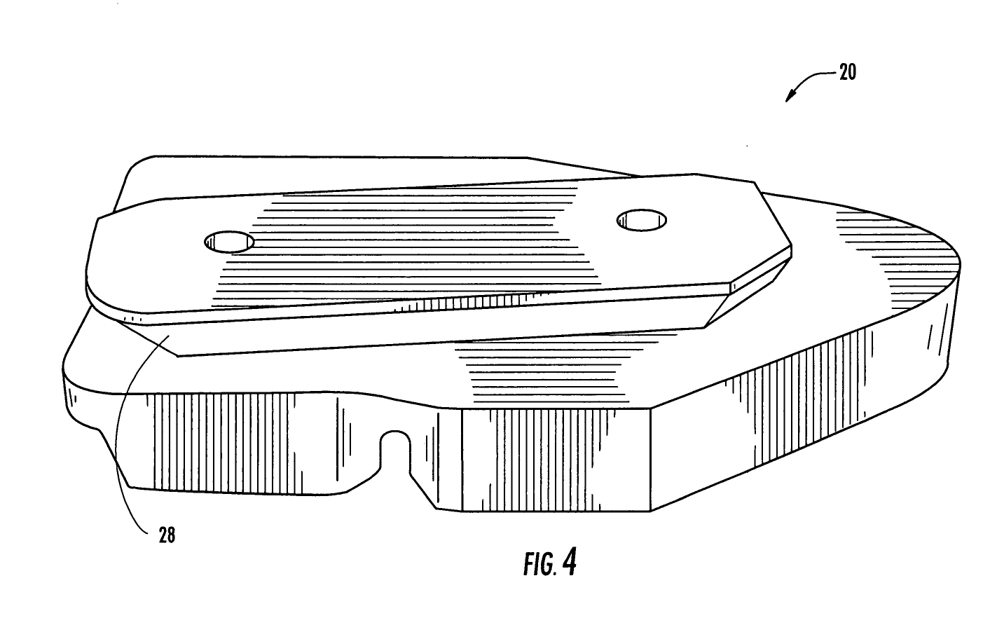

As can be seen in FIG. 3, the disc brake 20 has not gone through a deflashing process. Thus, as shown, the backing plate 26 has excess friction material, also known as flash 100, located within the dovetail guide 28. More specifically, it is often the case in the molding process that flash 100 will commonly reside on the outer portions of the dovetail guide 28 while the central portion of the dovetail guide 28 will remain relatively clean and free of flash 100. FIG. 4 shows the clean, deflashed disc brake 20 as may be accomplished by the processes and devices of the present invention described herein.

In particular, referring to FIG. 5, the deflashing device 10 includes first flash cutters 40, each with a first distal cutting end 41 and a first attachment end 49. The first attachment end 49 of the first flash cutters 40 may each additionally have a first pivot 48. As can be seen in FIG. 5, the cutting ends 41 of the cutters 40 are in direct contact with the dovetail guides 28 of the backing plate 26. The cutting ends 41 are configured with an angular profile for conforming to the contours of the dovetail guide 28. The position of the backing plate 26 between the cutting ends 41 of the cutters 40 is referred to as the engaged position, referring to the cutting ends 41 engaging, in direct contact, the dovetail guides 28 for deflashing the same.

As can be seen in FIG. 6, the cutters 40 may be released into a disengaged position via actuation of one or more push bars 66. Push bars 66 may be positioned within a push bar bore 67 and may be actuated together or individually in an upward direction to contact the underside of the cutter 40 causing at least one of the cutting ends 41 of the cutter 40 to rotate in an upward direction. As one or more cutting ends 41 are rotated upward, the backing plate 26 may then be released from between the cutters 40 and will thus disengage the dovetail guides 28 and permit removal of the disc brake 20.

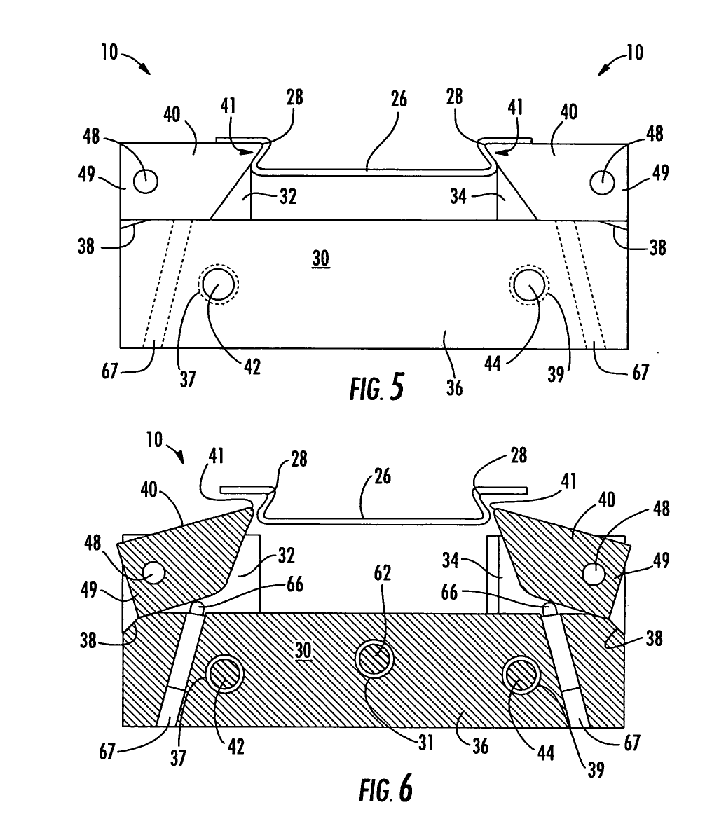

Second flash cutters 50, as illustrated in FIGS. 7, 8, 13, 14, 16, 18 and 19, may also be employed. FIGS. 7 and 8 provide detail of the second flash cutter 50, which is substantially similar to first flash cutter 40. The second flash cutter 50 has a second distal cutting end 51, a second attachment end 59 and a second pivot 58 positioned within the cutter 50. Like that illustrated in FIGS. 5 and 6 for first cutters 40, second cutter 50 likewise has an angular profile at the cutting end 51 for conforming to the contours of the dovetail guide 28. This angular profile may be varied for applications where the contour of the dovetail guide 28 may vary from a standard configuration.

FIGS. 5, 6, 9, 10 and 13 further illustrate a slide 30 that is connected to the cutters 40 at the attachment end 49. More particularly, the slide 30 has a rearward attachment portion 32 attaching to at least one cutter 40 via first pivot 48, and a forward attachment portion 34 attaching to at least one cutter 40 via first pivot 48. Each first pivot 48 may extend from one cutter 40 through a pivot bore 35 and connect to another cutter 40 positioned on an opposite side of the forward or rearward attachment portion 34, 32. In this embodiment, chamfer portions 38 are provided in the upper surface of a slide base 36 that is located at the outer extremes of the upper surface below cutters 40. Chamfer portions 38 thus allow cutters 40 to rotate in the upward direction about the first pivots 48. The base 36 and the rearward and forward attachment portions 32, 34 may be of a unitary construction or otherwise. The base 36 further provides a piston bore 31, a rearward slide guide bore 37 and a forward slide guide bore 39. Thus, a first rearward slide guide 42 may be positioned within the rearward slide guide bore 37 and a first forward slide guide 44 may be positioned within the forward slide guide bore 39. The slide 30 may further be connected to a first piston 62, which may be positioned within the piston bore 31.

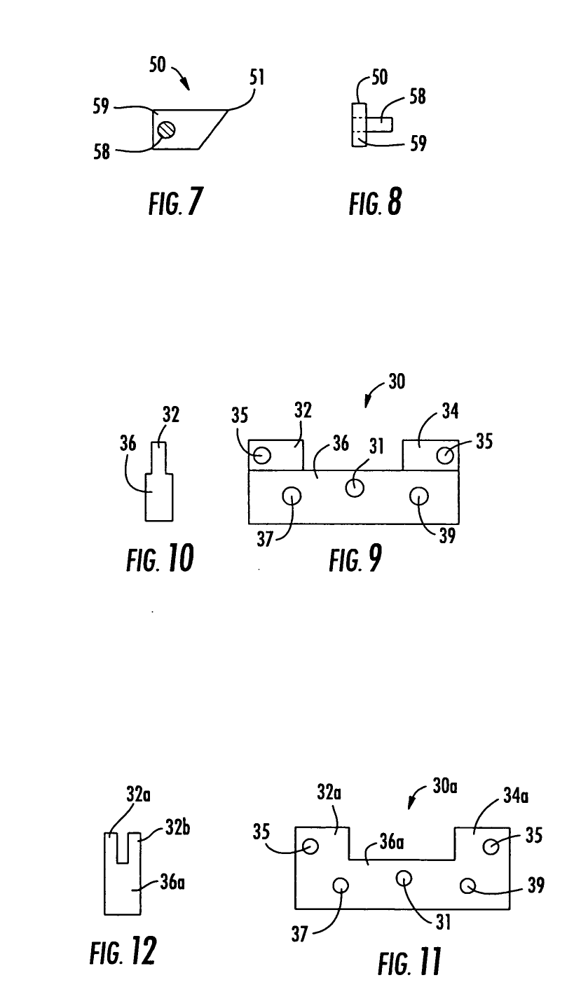

Referring to FIGS. 5, 6, 9, 10 and 13, the first cutters 40 are attached on either side of rearward and forward attachment portions 32, 34. The configuration of slide 30 permits attachment of the cutters 40 on either side of the rearward attachment portion 32, as shown in FIG. 10. Accordingly, the base 36 may be wider than the rearward and forward attachment portions 32, 34. This reduction in width is capable of accommodating at least one cutter 40, and preferably two cutters 40, on either side of the rearward attachment portion 32. Likewise, the forward attachment portion 34 is similarly constructed allowing two cutters 40 to be positioned thereon. Thus, the base 36 provides appropriate structure to allow cutters 40 to operate and be positioned properly.

Another embodiment of slide 30 provides an alternate slide 30a, as shown in FIGS. 11, 12. In this embodiment, only one pair of cutters 40 may be implemented having one cutter 40 positioned on a rearward side opposite another cutter 40 on a forward side. Thus, the first pivot 48 may be positioned through first alternate rearward attachment portion 32a, the cutter 40 and second alternate rearward attachment portion 32b. Likewise, opposite the rearward side, another cutter 40 may be similarly attached on the forward side of alternate slide 30a. Thus, the cutter 40 may still be positioned above an alternate slide base 36a such that it would allow cutters 40 to engage the dovetail guides 28. In addition, alternate slide 30a would likewise be provided with the piston bore 31, the rearward slide guide bore 37 and the forward slide guide bore 39.

A preferred embodiment of the deflashing device 10 is illustrated in FIG. 13. First and second cutters 40, 50 are attached to rearward attachment portions 32 and forward attachment portions 34. Each base 36 is connected to its respective first or second piston 62, 72. As mentioned above, one slide 30 has the piston bore 31 for receiving and attaching to the first piston 62. The other slide 30, attached to the second cutters 50, is similarly attached to the second piston 72. The attachment of slides 30 to pistons 62, 72 allows the slides 30 to be manipulated along the forward and rearward slide guides, 42, 44, 52, 54. Accordingly, slides 30 are slidably mounted to slide guides 42, 44, 52, 54 and travel therealong. In order to facilitate movement of the cutters 40, 50 in a linear direction away from each other, the first rearward and forward slide guides 42, 44 are provided for the first cutters 40 to travel along due to their connection to slide 30. Likewise, second rearward and forward slide guides 52, 54 are provided for the second cutters 50 for facilitating travel away from cutters 40. First and second rearward and forward slide guides 42, 44, 52, 54 remain stationary with respect to slides 30 and provide structure along which slides 30 may travel. In order to affix slide guides 42, 44, 52, 54 in a stationary position, first and second couplings 46, 56 are provided to assist in maintaining the position of the slide guides 42, 44, 52, 54.

In order to manipulate the cutters 40, 50, slides 30 rely on the first and second pistons 62, 72 which are driven by a first and a second slide actuator 60, 70. Actuators 60, 70 are capable of causing first and second pistons 62, 72 to move linearly away from and toward opposing actuators 60, 70. Actuators 60, 70 may employ known technologies to accomplish the extension and retraction of first and second pistons 62, 72 such as, for example, mechanical fluids, thermal energy, or electrical energy that may be converted into mechanical motion. Accordingly, pistons 62, 72 merely translate the forces provided by actuators 60, 70 given the motion provided by actuators 60, 70 for the given application.

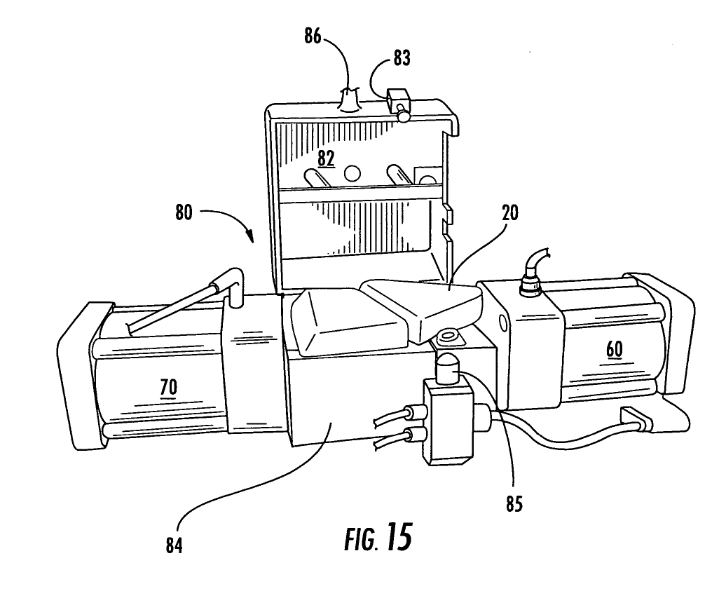

As illustrated in FIGS. 13-17, the deflashing device 10 may be in a rest position wherein the slides 30 that house first and second cutters 40, 50 are positioned in close proximity to one another. In this rest position, the cutters 40, 50, which are in the disengaged position, will be properly oriented to engage and contact the dovetail guides 28 of the disc brake 20 near the central portion of the dovetail guides 28. In use, an operator would position the disc brake 20 above the cutters 40, 50 and place the central portion of the dovetail guides 28 over the cutters 40, 50 as shown in FIGS. 15-17. The operator would then force the disc brake 20 downward into an engaging position with the cutters 40, 50, as illustrated in FIGS. 5 and 15-17. Once engaged, the operator would grasp a handle 86 to enclose a deflashing compartment 80, in which the deflashing device 10 is housed, by closing a compartment lid 82 having the handle 86 attached thereto until it reaches a compartment base 84. The lid 82 is attached to the base 84 via a compartment hinge 88 and further has an indicator 83. See FIGS. 14, 15, 17 and 19. Upon the lid 82 becoming closed, the indicator 83 would communicate to first and second actuators 60, 70 via receiver 85, causing the deflashing device 10 to be activated. Thus, indicator 83 would communicate with receiver 85 to cause the actuators 60, 70 to retract the first and second pistons 62, 72 attached to the slides 30. Thus, the pistons 62, 72 manipulate the cutters 40, 50 and cause them to travel toward their respective actuators 60, 70. Accordingly, the dovetail guides 28 will be deflashed and/or cleaned of flash 100 as the cutters 40, 50, in the engaged position, are forced along the dovetail guides 28 and are conformed to and in direct contact with the same. This contact between and travel along the dovetail guides 28 by the cutters 40, 50 may move, cut, slice, separate or otherwise deflash the flash 100 from the dovetail guides 28.

The deflashing device 10 may also include first and second end plates 64, 74, first locator 68 and/or second locator 78 as shown in FIGS. 13, 14, 16, 18 and 19. The end plates 64, 74 and first and second locators 68, 78 are illustrated in detail in FIGS. 22-30 and explained in greater detail below.

The first locator 68 may be provided to assist the deflashing device 10 from becoming misaligned. In the event that piston 62 is fully retracted toward its respective actuator 60, the cutters 40 may exit from engagement with the dovetail guide 28. If misalignment occurs, upon forcing of the piston 62 back to its rest position, wherein the slides 30 are in close proximity to one another, the deflashing device 10 may bind and/or damage the disc brake 20 confounding the purpose for deflashing. Thus, first locator 68 may assist in preventing such misalignment wherein the first locator 68 fits between cutters 40 and first end plate 64. As shown in FIGS. 22-24 and 25-27, first locator bores 69 may be provided for attaching the first locator 68 to the first end plate 64.

In order to accommodate first locator 68, the first end plate 64 may be provided with first end plate locator bores 69a. These bores 69a allow the first locator 68 to be attached in the proper orientation to prevent misalignment of the deflashing device 10. Thus, first locator 68 may attach to the first end plate 64 via fasteners (not shown) secured from the first end plate 64 into the first locator 68.

The second locator 78 may similarly assist the deflashing device 10 from becoming misaligned on the other side of the deflashing device 10. In the event that second piston 72 would become fully retracted toward its respective actuator 70, the cutters 50 may exit from engagement with the dovetail guide 28. Without second locator 78, upon forcing of the piston 72 back to its rest position, misalignment could occur in a similar fashion. Accordingly, the deflashing device 10 may bind and/or damage the disc brake 20. Thus, second locator 78 may prevent failure wherein the second locator 78 fits between cutters 50 and second end plate 74 to prevent misalignment. As shown in FIGS. 22a-24a and 28-30, second locator bores 79 may be provided for attaching the second locator 78 to the second end plate 74 via fasteners (not shown).

The second end plate 74 may also be provided with second end plate locator bores 79a as shown in FIG. 28. These second end plate locator bores 79a allow the second locator 78 to be attached in the proper orientation to prevent misalignment of the deflashing device 10 as discussed above. Accordingly, second locator 78 may attach to the second end plate 74 via fasteners (not shown) secured from the second end plate 74 into the second locator 78.

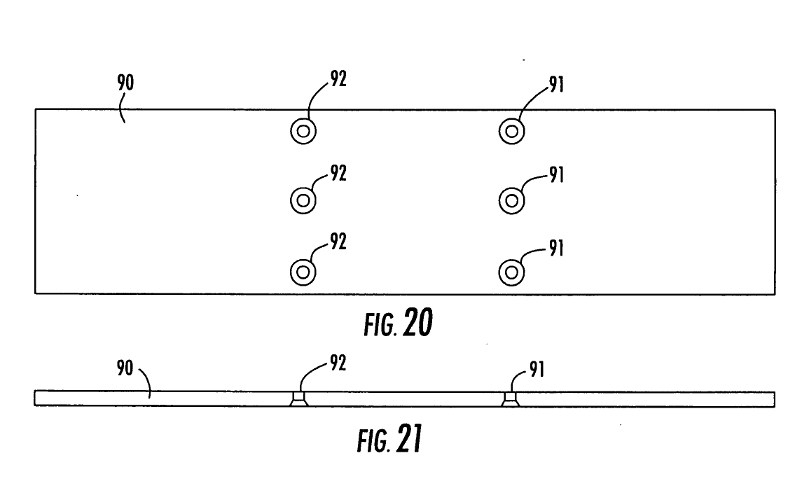

As shown in FIGS. 13, 20 and 21, the deflashing device 10 may have a device base 90 that may have positioned and/or attached thereon first and second slide actuators 60, 70 and first and second end plates 64, 74 via fasteners (not shown). First base bores 91 are provided for attachment to the first end plate 64 and second base bores 92 are provided for attachment to the second end plate 74.

FIGS. 25-27 illustrate in detail the first end plate 64 being further configured with a first rearward slide guide bore 63 for accommodating and connecting to the first rearward slide guide 42. First rearward slide guide 42 may be affixed within the first rearward slide guide bore 63 by the first coupling 46. Likewise, the first end plate 64 is configured with a first forward slide guide bore 65 for accommodating and connecting to the first forward slide guide 44 via first coupling 46. First piston bore 61 is also provided for accommodating and connecting to first piston 62. Lastly, as shown in FIG. 26, first end plate 64 may also have first end plate base bores 91a for securing the first end plate 64 to the device base 90 via fasteners (not shown).

The second end plate 74 is depicted in detail by FIGS. 28-30 and is configured similarly to first end plate 64. A second rearward slide guide bore 73 is provided for accommodating and connecting to the second rearward slide guide 52 via second coupling 56. The second end plate 74 is also configured with a second forward slide guide bore 75 for accommodating and connecting to the second forward slide guide 54 via second coupling 56. Second piston bore 71 is provided for accommodating and connecting to second piston 72. In addition, second end plate 74 has several second end plate base bores 92a for attaching, via fasteners (not shown), the second end plate 74 to the device base 90.

Once assembled as indicated above, the deflashing device 10 may be employed by an operator for safe and consistent deflashing of disc brakes 20 as shown in FIGS. 13-19.

Although the invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the spirit and scope of the appended claims. For example, it is to be understood that the present invention contemplates that, to the extent possible, one or more features of any embodiment can be combined with one or more features of any other embodiment.

The invention claimed is:

1. A deflashing device for removing excess friction material from a dovetail guide of a brake, said deflashing device comprising:
a base for supporting an actuator attached to said base;
a slide in communication with said actuator and positionable by said actuator;
at least one pair of cutters positioned on said slide opposed to one another and adapted to engage the dovetail guide of the brake; and
a slide guide attached to said base and in communication with said slide for slidably mounting said slide to said base, wherein said actuator manipulates said slide for removing excess friction material from the dovetail guide of the brake.

2. The deflashing device of claim 1, wherein said cutters have a cutting end adapted to engage the dovetail guide of the brake and an attachment end for attaching said cutters on said slide.

3. The deflashing device of claim 2, further comprising at least one push bar adapted to communicate with and reposition at least one of said cutters when said push bar is forced into contact with said at least one of said cutters.

4. The deflashing device of claim 3, wherein said cutters are pivotably attached to said slide at said attachment end of said cutters, and wherein said slide has chamfer portions adapted to permit said attachment end of said at least one of said cutters to be repositioned by said at least one push bar.

5. The deflashing device of claim 1, wherein said slide has opposing attachment portions each having at least one of said cutters positioned thereon.

6. The deflashing device of claim 1, wherein at least two pairs of cutters are positioned on said slide opposed to one another.

7. The deflashing device of claim 1, further comprising:
a second slide in communication with a second actuator attached to said base, wherein said second slide is positionable by said second actuator;
a second pair of cutters positioned on said second slide opposed to one another and adapted to engage the dovetail guide of the brake; and
a second slide guide attached to said base and in communication with said second slide guide for slidably mounting said second slide to said base, wherein said second actuator manipulates said second slide for removing excess friction material from the dovetail guide of the brake.

8. The deflashing device of claim 1, further comprising a lid having a handle attached, said lid adapted to enclose said slide and said cutters for protecting a user from said cutters when said lid is closed against a compartment base.

9. The deflashing device of claim 8, further comprising an indicator attached to said lid that communicates with said actuator when said lid is in a closed position to activate said actuator.

10. The deflashing device of claim 1, wherein a piston is positioned between said slide and said actuator to position said slide.

11. The deflashing device of claim 1, wherein said cutters have an angular profile for engaging and removing excess friction material from the dovetail guide of the brake.

12. The deflashing device of claim 1, wherein said slide guide is affixed to an end plate attached to said base at one end and attached to said slide at an opposing end of said slide guide.

13. The deflashing device of claim 12, further comprising a locator positioned on said end plate adapted to prevent said slide from being manipulated beyond said locator.

14. A deflashing device for removing excess friction material from a dovetail guide of a brake, said deflashing device comprising:
a base having a first end and a second end;
a first actuator attached to said first end of said base, said first actuator having a first piston extending away from said first actuator toward said second end;
a second actuator attached to said second end of said base, said second actuator having a second piston extending away from said second actuator toward said first end;
a first end plate attached to said base having said first piston extending therethrough;
a second end plate attached to said base having said second piston extending therethrough;
a first slide attached to said first piston having a forward attachment portion and a rearward attachment portion, wherein said attachment portions are positioned opposed to each other and each attachment portion having at least one first cutter positioned thereon;
a second slide attached to said second piston having a second forward attachment portion and a second rearward attachment portion, wherein said second attachment portions are positioned opposed to each other and each second attachment portion having at least one second cutter positioned thereon;
a first slide guide extending between said first end plate and said first slide for slidably mounting said first slide to said base, wherein said first actuator is adapted to manipulate said first slide toward said first end for removing excess friction material from the dovetail guide of the brake with said at least one first cutter; and
a second slide guide extending between said second end plate and said second slide for slidably mounting said second slide to said base, wherein said second actuator is adapted to manipulate said second slide toward said second end for removing excess friction material from the dovetail guide of the brake with said at least one second cutter.

15. The deflashing device of claim 14, further comprising a lid adapted to enclose said first and second slides and said first and second cutters for protecting a user from said first and second cutters when said first and second cutters are manipulated.

16. The deflashing device of claim 15, further comprising an indicator attached to said lid that communicates with said first and second actuators when said lid is in a closed position to activate said actuators.

17. The deflashing device of claim 16, wherein said first and second actuators manipulate said first and second slides toward each other when said lid is moved from a closed position with said indicator communicating with said first and second actuators to an open position wherein said indicator is no longer in communication with said first and second actuators.

18. The deflashing device of claim 16, wherein said first and second cutters have an angular profile for engaging and removing excess friction material from the dovetail guide of the brake.

19. The deflashing device of claim 16, further comprising a first locator positioned on said first end plate adapted to prevent said first slide from being manipulated beyond said first locator.

20. The deflashing device of claim 16, further comprising a second locator positioned on said second end plate adapted to prevent said second slide from being manipulated beyond said second locator.
